(19) United States
(12) Patent Application Publication
(10) Pub. No.: US 2019/0102063 A1
(43) Pub. Date: Apr. 4, 2019

(54) METHOD FOR DISPLAYING ICON AND RELATED TERMINAL

(71) Applicant: Lenovo (Beijing) Co., Ltd., Beijing (CN)

(72) Inventors: Minggui QIAN, Beijing (CN); Wenzhang WANG, Beijing (CN)

(21) Appl. No.: 15/993,916

(22) Filed: May 31, 2018

(30) Foreign Application Priority Data
Sep. 30, 2017 (CN) 201710915911.0

(51) Int. Cl. G06F 3/0481; G06K 9/00; G06F 3/0482; G06F 3/01

(52) U.S. Cl. CPC G06F 3/04817; G06F 3/011; G06F 3/0482; G06K 9/00006

(57) ABSTRACT

A method for displaying an icon is provided. The method for displaying an icon includes: detecting a trigger condition for displaying a target icon on a display screen; and in response to detecting the trigger condition, determining a target icon pattern from a plurality of icon patterns corresponding to the target icon. An icon display area of the display screen displays one or more of the plurality of icon patterns, and patterns of the plurality of icons are at least partially non-overlapping.

### CROSS-REFERENCES TO RELATED APPLICATIONS

This application claims the priority to Chinese Patent Application No. 201710915911.0, entitled “Method for Displaying Icon and Related Terminal,” filed on Sep. 30, 2017, the entire content of which is incorporated herein by reference.

### FIELD OF THE DISCLOSURE

The present disclosure relates to the field of information processing technologies and, more particularly, relates to a method for displaying an icon and related terminal.

### BACKGROUND

One or more virtual buttons for prompting a specific function may be provided on a display screen of a terminal. An icon corresponding to the virtual button may be displayed in a display area on the screen. For example, an icon of a “return” key for prompting a return function, or an icon of a “home” key for prompting the main menu as displayed at the bottom on a display screen. In other examples, some terminals may be equipped with a fingerprint authentication function. When a user needs to unlock the screen or make a payment, a fingerprint pattern for prompting the user to input the fingerprint may be displayed in a fingerprint recognition area on the screen of the terminal.

However, the service life of the screen of the terminal is limited. The regions where a screen displays patterns can age with the times of the pattern displays. As a result, the brightness level of the regions where the patterns are often displayed may gradually decay, eventually causing image retentions on the screen. Accordingly, it is desirable to reduce the speed of aging of the regions that repeatedly display icons on the screen.

### BRIEF SUMMARY OF THE DISCLOSURE

One aspect of the present disclosure provides a method for displaying an icon. The method may include: detecting a trigger condition for displaying a target icon on a display screen; and in response to detecting the trigger condition, determining a target icon pattern from a plurality of icon patterns corresponding to the target icon. An icon display area of the display screen may display one or more of the plurality of icon patterns, and patterns of the plurality of icons may be at least partially non-overlapping.

Another aspect of the present disclosure provides a terminal for displaying an icon, which may include a processor and a display screen coupled to the processor. The processor may be configured to detect a trigger condition for displaying a target icon on the display screen; and in response to detecting the trigger condition, determine a target icon pattern from a plurality of icon patterns corresponding to the target icon. An icon display area of the display screen may display one or more of the plurality of icon patterns, and patterns of the plurality of icons may be at least partially non-overlapping.

With the method and terminal as provided in the present disclosure, a number of displaying same pattern images of icon patterns at a fixed location can be reduced. As a result, the aging speed of the entire icon display area can be reduced, and the service life of the icon display area in the screen can be extended.

### BRIEF DESCRIPTION OF THE DRAWINGS

In order to explain the technical solutions of the embodiments of the present invention more clearly, the accompanying drawings required for describing the embodiments are briefly introduced in the following. Apparently, the accompanying drawings in the following description show merely some embodiments of the present invention. For those skilled in the art, drawings of other embodiments may also be obtained based on the present drawings without any creative work.

The following drawings are merely examples for illustrative purposes according to various disclosed embodiments and are not intended to limit the scope of the present disclosure.

FIG. 1 is a schematic flow diagram of a method for displaying an icon according to some embodiments of the present disclosure.

FIG. 2 is a schematic diagram of a plurality of icon patterns corresponding to a main menu icon according to some embodiments of the present disclosure.

FIG. 3 is a schematic flow diagram of another method for displaying an icon according to some embodiments of the present disclosure.

FIG. 4 is a schematic flow diagram of still another method for displaying an icon according to some embodiments of the present disclosure.

FIG. 5 illustrates a schematic structure of each layer of a display screen of a terminal with a fingerprint recognition area configured in the display screen.

FIG. 6 is a schematic diagram of a plurality of fingerprint patterns of a fingerprint icon according to some embodiments of the present disclosure.

FIG. 7 is a schematic structural diagram of a terminal according to some embodiments of the present disclosure.

### DETAILED DESCRIPTION

Reference will now be made in detail to exemplary embodiments of the present disclosure, which are illustrated in the accompanying drawings. Hereinafter, embodiments consistent with the disclosure will be described with reference to the drawings. Wherever possible, the same reference numbers will be used throughout the drawings to refer to the same or like parts. It is apparent that the described embodiments are some but not all of the embodiments of the present disclosure. Based on the disclosed embodiments, persons of ordinary skill in the art may derive other embodiments consistent with the present disclosure, all of which are within the scope of the present disclosure.

The method for displaying an icon according to some embodiments of the present disclosure may be applied to a terminal, such as a mobile phone, a tablet, a notebook computer, and the like that displays icons on a display screen. The icon may include a system icon of the terminal, such as a return key, a menu key, and the like that can be displayed on the display screen of the terminal. The icon may include a fingerprint icon used to prompt a user to input a fingerprint on the display screen of the terminal. The icon may also include an application icon displayed on the display screen of the terminal, etc. With the solution provided by the present disclosure, the aging of the icon display area can be slowed, and the service life of the screen area corresponding to the icon display area can be prolonged. Further, in the present disclosure, outputting an icon and displaying an icon may be used interchangeably when discussing implementations of the present disclosure in relation to various display screens.

The technical solutions provided by the embodiments of the present disclosure will be described clearly and completely hereinafter with reference to the accompanying drawings in the present invention. Apparently, the described embodiments are merely some but not all of the embodiments of the present invention. All other embodiments obtained by persons of ordinary skill in the art based on the embodiments of the present invention without any creative efforts shall fall within the protection scope of the present invention.

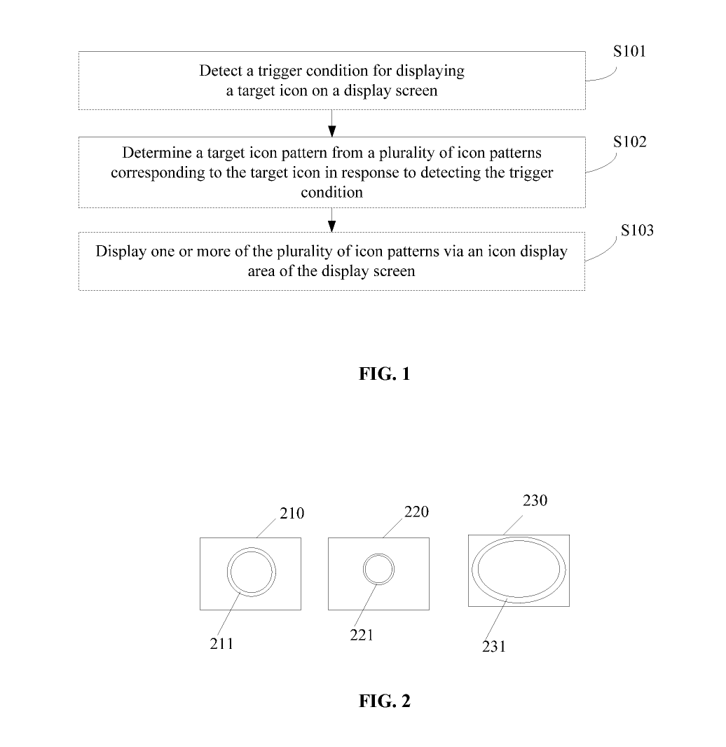

FIG. 1 shows a schematic flow diagram of a method for displaying an icon according to some embodiments of the present disclosure. The method may be implemented on a terminal, such as a mobile phone, a tablet, and the like. The method may include the following steps.

In S101: The display system may monitor and detect whether a trigger condition for displaying a target icon on a display screen is currently satisfied.

The target icon may be different icons according to different setting requirements. For example, the target icon may include a system icon, an application icon, or a fingerprint icon, etc.

Accordingly, when the target icon is different, the trigger condition of the target icon may also be different. In some embodiments, when the system icon is used, the system icon may be displayed each time when a user wakes up the screen. Therefore, waking up the screen may be a trigger condition for displaying the system icon. In some embodiments, the target icon may be the fingerprint icon. For example, the user may want to execute unlocking the screen by a fingerprint, a payment operation or identity authentication operation. The fingerprint icon may need to be displayed. Therefore, the trigger condition of the fingerprint icon may include one or more of: a fingerprint unlocking condition, a fingerprint payment condition, or a fingerprint authentication condition, and so on.

In some embodiments of the present disclosure, the method may include one or more target icons. However, for each target icon, the terminal maybe configured to output the icon pattern of the target icon, the technical solutions provided by the present disclosure may be implemented.

In S102: If the display system detects that the trigger condition is currently satisfied, the system may determine a target icon pattern from a plurality of preset icon patterns corresponding to the target icon.

Instead of each icon corresponding to one icon pattern, in some embodiments of the present disclosure, a plurality of icon patterns of a target icon may be prestored in the terminal. Each of the plurality of icon patterns may be a pattern that can be displayed in an icon display area of the target icon to prompt a function of the target icon. Taking the return key displayed on the display screen of the terminal as an example, in some embodiments of the present disclosure, the return key may correspond to a plurality of icon patterns. However, each of the plurality of icon patterns may be used to prompt that the displayed key is a return key. That is, each of the plurality of icon patterns may be used to indicate that the displayed key can be used to execute returning to a previous line, a previous page, or a previous menu.

The plurality of icon patterns of the target icon may be different from each other. In some embodiments, when the plurality of icon patterns of the target icon are displayed in the icon display area of the target icon, areas covered by the plurality of icon patterns may not overlap. For example, for each target icon, textures, shapes, or sizes of patterns of the plurality of icon patterns corresponding to the target icon may be different. Or, relative positions of the patterns of the plurality of icon patterns may be different so that, when the plurality of icon pattern are displayed in the icon display area of the target icon, the areas covered by the plurality of icon patterns do not completely overlap.

Because the icon display area of the target icon is located on the display screen, and the display screen displays the icon pattern of the target icon in the icon display area, a pattern image of the icon pattern may be displayed in a highlighted form. Therefore, a brightness level of the pattern image may be significantly higher than a background area of the icon pattern. As such, if the icon pattern displayed in the icon display area of the target icon remains unchanged, the area for displaying the pattern image in the icon display area may age very fast compared to other areas. Accordingly, the area in the icon display area for displaying the pattern image of the icon pattern may fail before other areas of the display screen. For example, even when the icon pattern of the target icon is not outputted to the display screen, a sticking image of the icon pattern may remain in the damaged icon display area.

In order to avoid the icon display area being unavailable because some areas in the icon display area of the target icon are aging faster, or more specifically, in order to reduce the aging speed of a fixed area in the icon display area of the target icon, it may be desirable to reduce or prevent the screen from always displaying the icon pattern at one identical location in the icon display area.

In some embodiments of the present disclosure, the target icon may include the plurality of icon patterns that have non-overlapping and different pattern images from each other. When the plurality of icon patterns are displayed in the icon display area of the target icon, the pattern images of the plurality of icon patterns, other than the background areas, do not significantly overlap with each other. Accordingly, if each of the plurality of the icon patterns is configured to be displayed, the system may avoid displaying the same highlighted image always at a fixed location in the icon display area of the target icon. That is, it is possible to display different pattern images of the icon patterns at different locations in the icon display area. Reducing the number of the times that the same pattern image is displayed at the same location in the icon display area further reduces the degree of screen aging and damage in the icon display area.

For ease of understanding, the icon of the main menu on the display screen of the mobile phone is used as an exemplary target icon. For example, referring to FIG. 2, three icon patterns of the main menu icon are shown. As shown in FIG. 2, three icon patterns of the main menu icon are icon pattern 210, icon pattern 220, and icon pattern 230, respectively. The three icon patterns may be of the same display size, so that the three icon patterns can all be displayed in the icon display area of the main menu icon. However, pattern images of the three icon patterns may not be the same. For example, the icon pattern 210, other than the background area, may include pattern image 211, the icon pattern 220 may include pattern image 221, and the icon pattern 230 may include pattern image 231. The pattern image 211, the pattern image 221, and the pattern image 231 may be all ring-shaped, but the shapes and sizes of the rings may be different so that, when the three icon patterns are displayed in the icon display area of the main menu icon, the pattern images of the three icon patterns do not overlap. That is, when the pattern images of the three icon patterns are displayed in the icon display area of the main menu icon, the display regions of the pattern images do not overlap.

In S103: The system may display one or more of the plurality of icon patterns via the icon display area on the display screen.

After the target icon pattern to be displayed in the icon display area of the target icon is determined, outputting the target icon pattern in the icon display area may be implemented using any existing manner of outputting the icon pattern, which is not limited herein.

It can be understood that, the icon patterns as determined to be outputted may be different each time whenever the trigger condition of the target icon is satisfied. And pattern images of different icon patterns may also have different display regions in the icon display area of the target icon. Therefore, if the target icons are outputted at different times, the highlighted areas in the icon display area of the target icon may also be different. As a result, the number of displaying the pattern images of the icon patterns at a fixed location can be reduced to avoid that the faster aging of the display screen at the fixed location of the icon display area. Further, embodiments of the present disclosure can reduce the aging speed of the entire icon display area of the target icon and prolong the service life of the icon display area.

It should be noted that, in some embodiments of the present disclosure, when the plurality of preset icon patterns of the target icon are displayed in the icon display area of the target icon, the pattern images of the plurality of icon patterns may not overlap. In some embodiments, the pattern images of the plurality of icon patterns may be at least partially non-overlapping.

It can be understood that, in order to increase the area in the icon display area of the target icon that can display the pattern images, the pattern images of the plurality of icon patterns do not overlap. That is, the pattern images of the plurality of icon patterns do not overlap with each other. As shown in FIG. 2, the pattern images of each icon patterns corresponding to the main menu icon do not overlap completely. In this configuration, since the pattern images of the icon patterns do not overlap, when outputting different icon patterns of the target icon, the highlighted areas in the icon display area of the target icon would be different. It accordingly reduces the aging speed of the display screen at each location in the icon display area of the target icon and reduces the aging speed compared to displaying the icon pattern only at a fixed location or in a small area.

Still taking the main menu icon shown in FIG. 2 as an example for description, and assuming that the main menu icon currently only corresponds to the icon pattern 210, for each time when the main menu icon is outputted, only the pattern image 221 of the icon pattern 210 can be displayed in the icon display area of the main menu icon. If the main menu icon is outputted 100 times, the pattern image 211 will be outputted in the icon display area of the main menu icon 100 times. That is, the number of times that the output location in the highlighted form corresponding to the pattern image 211 in the icon display area will also reach to 100 times. With respect to the area in the icon display area where the pattern image 211 is not displayed, the aging effect of the highlighted area would be obvious. And it is likely to result in the problem of image retentions or even failure because the screen aging of the area used for repeatedly outputting the pattern image 211 in the icon display area.

However, after applying the solutions of the present disclosure, since the icon patterns used for displaying the main menu icon each time may be different, even if the main menu icon is outputted 100 times, the number of outputting the pattern image 211 in the icon display area of the main menu will be greatly reduced. And the number of times that the pattern image 221 of the pattern icon 220 and the pattern image 231 of the pattern icon 230 are displayed in the icon display area will be increased. As a result, the number of times for displaying each pattern image will be fewer than 100 times, thereby reducing the aging speed of the screen area corresponding to the location for displaying the pattern image 210 in the icon display area. Moreover, since the number of times for displaying each pattern image in the icon display area is less than the number of output times of the main menu icon, the aging speed of the area for displaying the different pattern images in the icon display area of the main menu icon would be slowed down, which is favorable for reducing the overall aging effect of the icon display area.

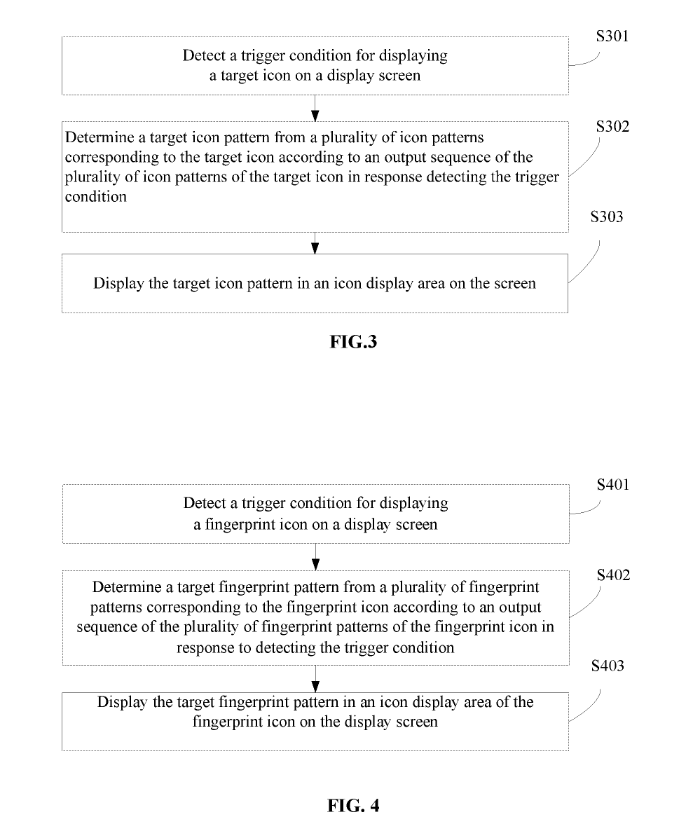

It can be understood that, in some embodiments of the present disclosure, the method may include multiple ways for selecting the target icon pattern to be currently outputted. For example, as shown in FIG. 3, which illustrates another method for displaying an icon according to some embodiments of the present disclosure. The method may include the following steps.

In S301: The display system may monitor and detect whether a trigger condition for displaying a target icon on a display screen is currently satisfied.

Reference may be made to the related description in the foregoing embodiments, which is not described herein again.

In S302: If it is detected that the trigger condition is currently satisfied, the method may include determining a target icon pattern from a plurality of preset icon patterns corresponding to the target icon according to an output sequence of the plurality of preset icon patterns of the target icon.

Each of the plurality of icon patterns may be a pattern for prompting a function of the target icon in the icon display area of the target icon. When the plurality of icon patterns of the target icon are displayed in the icon display area of the target icon, areas covered by the pattern images of the plurality of icon patterns, other than the background areas, do not overlap.

It can be understood that the output sequence of the plurality of icon patterns of the target icon may be set as needed. The output sequence of the plurality of icon patterns can be an order of the icon patterns to be outputted when the target icon is outputted at different times.

When the trigger condition is satisfied, the icon pattern currently to be outputted from the plurality of icon patterns may be determined as the target icon pattern according to the output sequence. For example, assuming that the target icon has five icon patterns, i.e. icon patterns 1 to 5 respectively, the output sequence of the five icon patterns may be sequentially icon pattern 1, icon pattern 2, icon pattern 3, icon pattern 4, and icon pattern 5. It is assumed that, when the target icon is outputted last time, the icon pattern as outputted is the icon pattern 4. And the target icon pattern currently to be outputted may be the icon pattern 5 according to the output sequence of the icon patterns. Accordingly, when the trigger condition for outputting the target icon is satisfied next time, the icon pattern to be outputted may be the icon pattern 1.

It can be understood that the target icon pattern currently to be outputted may be determined according to the output sequence of the plurality of icon patterns to make the output times for each of the plurality of icon patterns identical or nearly identical. In this way, the number of times that the different areas for displaying the pattern images of the different icon patterns are highlighted will be generally the same, so that the different areas of the icon display area in the display screen are more evenly aged. Accordingly, the service life of the screen of the icon display area may be extended up to a multiple equal to the number of the preset icon patterns.

For example, when the plurality of preset icon patterns of the target icon are displayed in the icon display area of the target icon, if the pattern images of the plurality of icon patterns do not overlap with each other, and the number of the plurality of preset icon patterns is n, the service life of the icon display area of the target icon will then become n times longer in reference to the original service life.

The three icon patterns of the main menu icon shown in FIG. 2 are used again as an example for description. In one example, the screen in the icon display area of the main menu icon can bear a maximum of 100 times of highlighted image outputs, and the main menu icon only corresponds to the icon pattern 210. Since the location of the pattern image 211 for outputting the icon pattern 210 in the icon display area of the main menu icon is fixed, the number of times for outputting the icon pattern 210 in that location is 100 times. As a result, due to the screen aging of that location, the icon display area would become damaged or may fail.

However, by implementing the technical solutions provided by the present disclosure, as the icon patterns used for outputting the main menu icon may be different each time, the pattern image of each icon pattern does not coincide with another in the icon display areas of the main menu icons. In this way, even if the number of times for outputting the main menu icon is 100 times, the number of times for displaying the pattern image 211 in the icon display area of the main menu, the number of times for displaying the pattern image 221 of the pattern icon 220, and that for displaying the pattern image 231 of the pattern icon 230 would be each about 30 times. Accordingly, the aging effect of the three locations for displaying the pattern images of different icon patterns in the icon display area will be relatively reduced. It will also result in reducing the screen aging of a certain location in the icon display area which may render the icon display area unavailable. With reference to FIG. 2, in a case where the screen of aging can endure 100 times of highlighting, the icon display area of the main menu icon may output 100 times of each the three patterns of images, respectively. That is, the total number of times that the icon display area can output the icon patterns of the main menu icon will become 300 times, which in turn triples the screen service life in the icon display area.

In some embodiments, the display system may determine the target icon pattern currently to be outputted according to the output sequence of the plurality of icon patterns of the target icon. However, the present disclosure is not limited to this specific manner. For example, if the trigger condition is satisfied, an icon pattern that was displayed most recently may also be identified from the plurality of preset icon patterns of the target icon. Then, by excluding this icon pattern from the plurality of icon patterns, they display system may determine the target icon pattern to be displayed. As stated, the method for determining the target icon pattern can reduce the degree of screen aging in the icon display area of the target icon and improve the service life of the icon display area.

In S303: The target icon pattern may be displayed in the icon display area on the display screen.

Regarding S303, reference may be made to the related description in the foregoing embodiments, and details will be not repeated herein again.

The below describes another method for displaying an icon according to some embodiments of the present disclosure by taking a fingerprint icon as the target icon for an example.

FIG. 4 is a schematic flow diagram of still another method for displaying an icon according to some embodiments of the present disclosure. The method of the embodiments may be applied to a terminal that has a screen. The method may include the following steps.

In S401: The display system may monitor and detect whether a trigger condition for displaying a fingerprint icon on a display screen is currently satisfied.

In some embodiments, the target icon may be the fingerprint icon which is outputted on the display screen and used to prompt the user to input a fingerprint.

It can be understood that, with the continuous development of large screens or full screens, configuring a fingerprint recognition area on the display screen has become a trend. In order to prompt a user to verify the fingerprint on the display screen, the fingerprint icon for prompting the user of the fingerprint recognition area may be required. And if the fingerprint entered by the user is required, the fingerprint icon may be displayed in the fingerprint recognition area of the screen to prompt the user to provide the fingerprint in the icon display area.

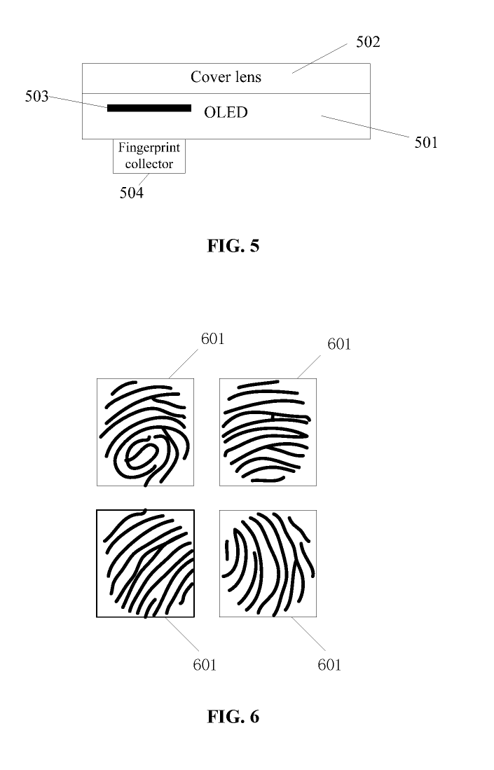

In the descriptions below, reference may be made to FIG. 5 which illustrates a schematic structure of a screen of a terminal with a fingerprint recognition area configured in the screen. As shown in FIG. 5, the screen of a terminal may include an organic light-emitting display 501 with at least one organic light-emitting diode (OLED). In some embodiments, the screen may include a touch screen, but not limited to herein. One upper layer of the screen may be a cover lens 502, also referred to as a cover glass, which may serve to protect the screen. The screen may include a fingerprint display area 503 for displaying the fingerprint icon, and a fingerprint collector 504 disposed below the fingerprint display area 503. In some embodiments, the fingerprint collector 504 may include an optical fingerprint collector that adopts an optical fingerprint collection method, a radio frequency fingerprint collector that uses bio-radio frequency identification technology, or a thermal fingerprint collector, etc., but not limited to herein. Due to the large area of the screen, it is difficult for the user to accurately locate the fingerprint collection area corresponding to the fingerprint collector in the screen whenever the user needs to input the fingerprint. Therefore, the fingerprint icon may be displayed to prompt the user of the fingerprint collection area above the fingerprint collector.

Satisfying the trigger condition for displaying the fingerprint icon on the display screen may include: satisfying the trigger condition of the fingerprint unlock screen or meeting the trigger condition of the fingerprint authentication. For instance, when making a payment or entering an encryption interface in the terminal, the fingerprint authentication of the user may be required. In this case, the trigger condition of the fingerprint authentication may be satisfied. There may be other possibilities for the trigger condition for displaying the fingerprint icon on the display screen, which is not limited herein.

In S402: If it is detected that the trigger condition is currently satisfied, the method may include determining a target fingerprint pattern to be outputted from a plurality of preset fingerprint patterns of the fingerprint icon according to an output sequence of the plurality of preset fingerprint patterns of the fingerprint icon.

Each of the plurality of fingerprint patterns may be displayed in an icon display area of the fingerprint icon and may be used for prompting the fingerprint collection area corresponding to the fingerprint icon. When the plurality of fingerprint patterns are displayed in the icon display area of the fingerprint icon, fingerprint textures of the plurality of fingerprint patterns do not substantially overlap.

It can be understood that the fingerprint texture of each fingerprint pattern is equivalent to the pattern image of the fingerprint icon. When the fingerprint pattern of the fingerprint icon is displayed, a display brightness of the fingerprint texture of the fingerprint pattern may be higher than the background in the fingerprint pattern. Therefore, if the fingerprint texture of the fingerprint pattern is always displayed at a fixed position in the icon display area of the fingerprint icon, the location the fingerprint texture displayed in the icon display area of the fingerprint icon would age faster.

To prevent the same fingerprint texture from being always displayed at a fixed position in the icon display area of the fingerprint icon each time for outputting the fingerprint icon, in some embodiments of the present disclosure, the plurality of fingerprint patterns of the fingerprint icon may be pre-stored. And the plurality of fingerprint patterns may include different fingerprint textures. When the different fingerprint patterns are displayed in the icon display area of the fingerprint icon, distribution locations of the fingerprint textures may be different. Therefore, the fingerprint textures may be effectively displayed by using different distribution locations in the icon display area of the fingerprint icon on the display screen. As a result, embodiments of the present disclosure can reduce the aging speed of the entire icon display area and prolong the service life of the icon display area in the screen. For example, when the fingerprint icon has n fingerprint patterns, the service life of the icon display area of that fingerprint icon may be n times of the service life of the icon display area of the fingerprint icon of using one fingerprint pattern.

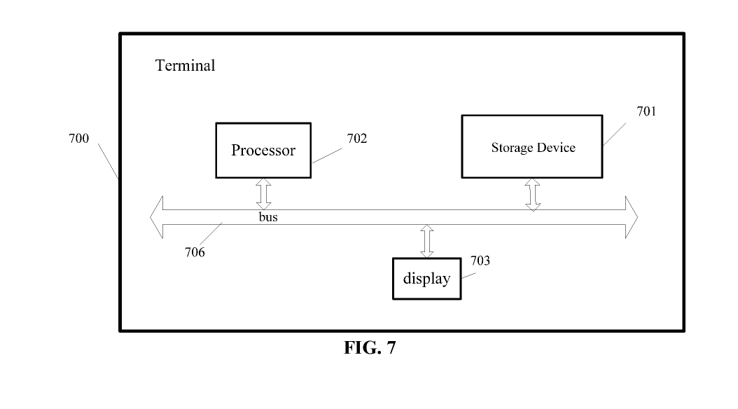

For example, FIG. 6 illustrates four fingerprint patterns corresponding to one fingerprint icon. As shown in FIG. 6, distributions of the fingerprint textures of the four fingerprint patterns 601 may be different from each other. Since the size of each fingerprint pattern may be the same, by assuming that the size of the fingerprint pattern is identical to that of the icon display area of the fingerprint icon, the fingerprint texture distribution in the fingerprint pattern can be regarded as the distribution location of the fingerprint texture in the icon display area of the fingerprint icon. It can be seen from FIG. 6 that when the four fingerprint patterns are displayed in the icon display area of the fingerprint icon, the distribution locations of the fingerprint textures do not coincide with each other. Accordingly, if the output sequence of the four fingerprint patterns is preset for outputting a fingerprint pattern every time when the trigger condition is satisfied according to the output sequence, a fingerprint may be displayed each time at different locations in the icon display area. The number of times for displaying the fingerprint pattern in the icon display area can be accordingly increased by 4 times. Further reference can be made to the foregoing description for deducing the times of increasing the number for outputting the icon patterns in the icon display area corresponding to the main menu icon.

It can be understood that, in order to reasonably and evenly use any pixel location in the icon display area of the fingerprint icon, in some embodiments of the present disclosure, a coverage area of each fingerprint texture of the plurality of fingerprint patterns may be configured to approximately be an area of the fingerprint icon in the icon display area on the display screen. Accordingly, each time the fingerprint icon is displayed, a location for displaying each fingerprint texture in the icon display area of the fingerprint icon may be different, and each location point in the icon display area of the fingerprint icon may be used for displaying the fingerprint textures. Accordingly, each location point in the icon display area of the fingerprint icon can be effectively utilized so that it can avoid the problem related to the faster aging of a certain region in the icon display area of the fingerprint icon on the display screen in comparison to another portion of the screen.

It can be understood that, in some embodiments of the present disclosure, the target fingerprint pattern to be outputted may be determined from the plurality of present fingerprint patterns of the fingerprint icon according to the output sequence of the plurality of preset icon patterns of the fingerprint icons. In some embodiments, there may be other ways to determine the target fingerprint pattern to be outputted from the plurality of fingerprint patterns. In other embodiments, the manners as mentioned in the foregoing may also be implemented to determine the target fingerprint pattern currently to be outputted, the description of which is not repeated herein.

In S403: The target fingerprint pattern may be displayed in the icon display area of the fingerprint icon on the display screen.

After the target fingerprint pattern is displayed in the icon display area of the fingerprint icon of the screen, the user may identify the fingerprint recognition area according to the display location of the target fingerprint pattern. The user may put his finger on the display screen region where the target fingerprint pattern is located, so that the fingerprint collector below the screen can capture and identify the user's fingerprint.

It can be understood that, in the embodiment of FIG. 4, the fingerprint icon is taken as the target icon for an example. In the previous examples, the system icon (e.g. the main menu icon) is taken as the target icon, and the process of outputting the icon pattern of the system icon is introduced. However, in some embodiments when the target icon is another type of icons, FIG. 4 and any one of the preceding embodiments are still applicable. For example, when the target icon is an application icon, the target icon pattern currently to be outputted may be determined from the plurality of preset icon patterns of the application icon if the trigger condition for outputting the application icon is satisfied. And the target icon pattern may be displayed in the icon display area of the application icon. The triggering condition for outputting the application icon may be the same as the condition for outputting the application icon currently. For example, when an interface containing the application icon needs to be displayed, the triggering condition for outputting the application icon may be determined. It is apparent that other triggering conditions may also be provided, which are not described herein.

In some embodiments, to support the above-disclosed method for displaying an icon, another aspect of the present disclosure further provides a terminal, which may include a terminal with a screen, such as a mobile phone, a tablet computer, and the like.

In some embodiments, referring to FIG. 7 which shows a schematic structural diagram of a terminal according to some embodiments of the present disclosure. The terminal 700 may include a storage device 701, a processor 702, and a display 703.

The storage device 701 may be configured to save a plurality of specified icon patterns of a target icon in advance.

The processor 702 may be configured to monitor whether a trigger condition for displaying the target icon on the screen is currently satisfied. And if it is detected that the trigger condition is currently satisfied, the processor 702 may be configured to determine a target icon pattern currently to be outputted from the plurality of preset icons patters of the target icon. Each of the plurality of icon patterns may be a pattern for displaying a function of the target icon in an icon display area of the target icon. When the plurality of icon patterns are displayed in the icon display area, a location covered by a pattern image of the plurality if the icon patterns, other the background area, do not overlap.

The display 703 may be configured to display the target icon pattern in the icon display area on the screen.

In some embodiments, the storage device 701, the processor 702, and the display 703 may be connected by a communication bus 706.

In some embodiments, when determining the target icon pattern to be currently outputted from the plurality of preset icon patterns of the target icon, the processor 702 may be configured to identify an icon pattern that was displayed most recently from the plurality of preset icon patterns of the target icon and determine the target icon pattern to be displayed from the plurality of preset icon patterns by excluding the previously displayed icon pattern.

In some embodiments, the screen of the terminal 700 may include an icon display area, and a fingerprint collector for collecting fingerprints is provided below the icon display area.

In some embodiments, the storage device 701 may be configured to store a plurality of fingerprint patterns of the fingerprint icon.

When monitoring whether the trigger condition for displaying the target icon on the screen is currently satisfied, the processor 702 may be configured to monitor whether the trigger condition for outputting a fingerprint icon to the screen is currently satisfied.

When selecting the target icon pattern to be currently outputted from among the plurality of preset icon patterns of the target icon, the processor 702 may be configured to determine a target fingerprint pattern to be outputted from a plurality of preset fingerprint patterns of the fingerprint icon. When the plurality of preset fingerprint patterns are displayed in the icon display area, fingerprint textures of the plurality of present fingerprint patterns are at least partially non-overlapping.

In some embodiments, a coverage area of each fingerprint texture of the plurality of preset fingerprint patterns stored in the memory is approximately an area of the icon display area of the specified icon on the screen.

The techniques of the present disclosure may be implemented in the form of hardware and/or software (including firmware, microcode, etc.). In addition, the techniques of the present disclosure may have the form of a computer program product on a computer readable medium in which the instructions are stored. And the computer program product may be used by or in connection with an instruction execution system. In the context of the present disclosure, the computer readable medium may refer to any medium that can contain, store, communicate, propagate, or transport the instructions. For example, the computer readable media may include but are not limited to electrical, magnetic, optical, electromagnetic, infrared, or semiconductor systems, devices, devices, or propagation medium. Specific examples of the computer readable medium may include a magnetic storage device such as a magnetic tape or a hard disk (HDD); an optical storage device such as a compact disc (CD-ROM); a memory such as a random-access memory (RAM) or a flash memory; and/or wireless/wired communication link.

Logic when implemented in software, can be written in an appropriate language such as but not limited to C# or C++, and can be stored on or transmitted through a computer-readable storage medium (e.g., that is not a transitory signal) such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc.

The techniques of the present disclosure may be implemented in a computer-readable storage medium. The computer-readable storage medium, for example, may include any medium that can contain, store, communicate, propagate, or transport the instructions. For example, the readable storage media may include, but are not limited, to electrical, magnetic, optical, electromagnetic, infrared, or semiconductor systems, devices, devices, or propagation media. Specific examples of the readable storage medium may include a magnetic storage device such as a magnetic tape or a hard disk (HDD), an optical storage device such as a compact disk (CD-ROM); a memory such as random-access memory (RAM) or a flash memory, and/or wireless/wired communication link.

The computer-readable storage media may include a computer program, which may include codes/computer-executable instructions that, when executed by a processor, cause the hardware processor to execute, for example, the steps of the methods described above with reference to FIGS. 1, 3, and 4, and any variation thereof.

The computer program may be configured with computer program codes, including, for example, a computer program module. In some embodiments, the codes in the computer program may include one or more program modules. It should be noted that the division manner and the number of modules is not fixed, and those skilled in the art may apply appropriate program modules or any combination of program modules according to actual situations. When these program module combinations are executed by the processor, the processor may be configured to, for example, execute the methods described above with reference to FIGS. 1, 3, and 4, and any variations thereof.

In some embodiments, a full-screen device provided by the present disclosure arranges the fingerprint collector below the screen to increase a proportion of the screen. When a function requesting for fingerprint collection, such as system wake-up, a payment operation or identity authentication operation, and the like, is triggered, a fingerprint icon above the fingerprint collection location on the screen may be displayed to prompt and inform the user that the displayed area is the fingerprint collection region, so that the user can be guided to press the specified location. After the user's finger touches on the area, the system may directly adjust the brightness of the OLED in the area to the maximum, adjust the brightness based on an ambient light, or gradually adjust to the maximum to provide a light source for an optical fingerprint collector. The light of the OLED may be transmitted to the finger and reflected to a fingerprint verification chip for fingerprint verification. In some embodiments, different fingerprint icons may be displayed on the screen as a guide and prompt, each time when the function for fingerprint collection is triggered, to inform the user that this area on the screen is the fingerprint collection area. By still providing the prompt function to the user, the solutions offered by the present disclosure effectively solve the problem of the reduced service time of the OLED in the collection area and the problem of the sticking image caused by displaying the fingerprint icons at a fixed location. Further, in some embodiments, different fingerprint icons may be displayed respectively in a fingerprint collection.

The above description of the disclosed embodiments enables those skilled in the art to make or use the invention. Various modifications to these embodiments will be readily apparent to those skilled in the art, and the generic principles defined herein may be embodied in other embodiments without departing from the spirit or scope of the invention. Therefore, the present disclosure should not be limited to these embodiments shown herein, but rather should be in accordance with the broadest scope consistent with the principles and novel features disclosed herein, and in view of the following claims.

What is claimed is:

1. A method for displaying an icon, comprising:
detecting a trigger condition for displaying a target icon on a display screen;
in response to detecting the trigger condition, determining a target icon pattern from a plurality of icon patterns corresponding to the target icon, wherein:
one or more of the plurality of icon patterns are displayed via an icon display area of the display screen, and
the plurality of icon patterns are at least partially non-overlapping upon being displayed via the icon display area of the display screen.

2. The method of claim 1, further comprising:
selecting the target icon pattern from the plurality of icon patterns according to an output sequence of the plurality of icon patterns of the target icon.

3. The method of claim 1, further comprising:
determining a previously displayed icon pattern from the plurality of icon patterns; and
excluding the previously displayed icon pattern when determining the target icon pattern from the plurality of icon patterns.

4. The method of claim 1, wherein the target icon is a fingerprint icon.

5. The method of claim 4, wherein: a coverage area of each fingerprint pattern of a plurality of fingerprint patterns approximately equals to an area of the icon display area of the fingerprint icon on the display screen.

6. The method of claim 1, wherein the target icon includes any one of a system icon, an application icon, and a fingerprint icon.

7. The method of claim 6, wherein the target icon is the system icon, and the trigger condition is a wake-up operation on the display screen.

8. The method of claim 6, wherein the target icon is the fingerprint icon, and the trigger condition is any one of an unlocking operation, a payment operation, or an identity authentication operation on the display screen.

9. The method of claim 1, wherein the plurality of icon patterns are displayed in at least partially non-overlapping regions of the icon display area of the display screen.

10. The method of claim 1, wherein each of the plurality of icon patterns is identical in size.

11. The method of claim 1, wherein:
each of the plurality of icon patterns includes a pattern image, and
the pattern images are of a similar shape but of different sizes.

12. A terminal for displaying an icon, comprising:
a processor; and
a display screen coupled to the processor, wherein:
the processor is configured to:
detect a trigger condition for displaying a target icon on the display screen; and
in response to detecting the trigger condition, determine a target icon pattern from a plurality of icon patterns corresponding to the target icon, wherein:
one or more of the plurality of icon patterns are displayed via an icon display area of the display screen, and
the plurality of icon patterns are at least partially non-overlapping upon being displayed via the icon display area of the display screen.

13. The terminal of claim 12, wherein the processor is configured to select the target icon pattern to be displayed from the plurality of icon patterns according to an output sequence of the plurality of icon patterns of the target icon.

14. The terminal of claim 12, wherein the processor is configured to:
identify a previously displayed icon pattern from the plurality of icon patterns of the target icon; and
exclude the previously displayed icon pattern when determining the target icon pattern from the plurality of icon patterns.

15. The terminal of claim 12, wherein:
the display screen further includes a fingerprint collector and
the processor is further configured to:
select a target fingerprint pattern to be displayed from the plurality of fingerprint patterns corresponding to a fingerprint icon, wherein the plurality of fingerprint patterns are at least partially non-overlapping when displayed in the icon display area of the display screen.

16. The terminal of claim 15, wherein: a coverage area of each fingerprint of the plurality of fingerprint patterns corresponds to an area of the icon display area on the display screen.

17. The terminal of claim 12, wherein the target icon includes any one of a system icon, an application icon, and a fingerprint icon.

18. The terminal of claim 12, wherein the display screen is configured to display the plurality of icon patterns so that the icon patterns are at least partially non-overlapping regions upon display via the icon display area of the display screen.

19. The terminal of claim 12, wherein each of the plurality of icon patterns is identical in size.
